(19) United States
(12) Patent Application Publication
(10) Pub. No.: US 2010/0238085 A1
(43) Pub. Date: Sep. 23, 2010

(54) PLASTIC WAVEGUIDE SLOT ARRAY AND METHOD OF MANUFACTURE

(75) Inventors: Michael Yiin-kuen Fuh, Berkeley, CA (US); Alexandros Margomenos, Ann Arbor, MI (US); Liwei Lin, Castro Valley, CA (US)

Correspondence Address: GIFFORD, KRASS, SPRINKLE,;ANDERSON & CITKOWSKI, P.C., P.O. BOX 7021, TROY, MI, 48007-7021, US

(73) Assignees: Toyota Motor Engineering & Manufacturing North America, Inc., Erlanger, KY (US); University of California, Berkeley, Berkeley, CA (US)

(21) Appl. No.: 12/409,262

(22) Filed: Mar. 23, 2009

(51) Int. Cl. H01Q 13/10; H01P 11/00

(52) U.S. Cl. 343/771; 29/600

(57) ABSTRACT

The present invention discloses a waveguide antenna structure and a method of manufacture. The waveguide antenna structure can include a non-metallic substrate having a waveguide channel extending along a first direction and an inlet channel extending along a second direction. The inlet channel intersects with the waveguide channel and both channels are at least partially coated with a metallic material. The waveguide channel can have a generally U-shaped cross-section with an open side that is at partially enclosed by a slot plate that is attached to the non-metallic substrate.

### FIELD OF THE INVENTION

The present invention is related generally to a waveguide slot array, and in particular, to a waveguide slot array made from plastic.

### BACKGROUND OF THE INVENTION

Waveguide antennas having slots to serve as radiating and/or receiving elements are known. Within the waveguide antennas is a waveguide channel through which electromagnetic waves are propagated. On one face of the waveguide channel, slots are typically present through which the electromagnetic waves can be transmitted and/or received.

The design and structure of a particular waveguide antenna is dictated to a large extent by the frequency of electromagnetic waves that are to be transmitted and/or received. In addition, particular frequency's or range of frequencies have selective uses. For example, 22 GHz, 30 GHz and 40 GHz frequencies are reserved for military applications, the 60 GHz frequency is used for Internet wireless local area networks (LAN) and the range of 63-1000 GHz frequencies are used for long-range radar.

As higher frequencies are propagated through the waveguide channel and inlet channel, the surface roughness of the internal surfaces of the channels becomes a critical issue with respect to the operation capability of the waveguide antenna. As such, most long-range radar waveguide antennas are made from metal components that have machined and sometimes polished surface in order to provide necessary surface finishes. However, the production of machined and/or metal components results in high manufacturing costs. Therefore, a waveguide antenna that is made from a cost-efficient process and yet provides the necessary surface finish would be desirable.

### SUMMARY OF THE INVENTION

The present invention discloses a waveguide antenna structure and a method of manufacture. The waveguide antenna structure can include a non-metallic substrate having a waveguide channel extending along a first direction and an inlet channel extending along a second direction. The inlet channel intersects with the waveguide channel and both channels are at least partially coated with a metallic material. The waveguide channel can have a generally U-shaped cross-section with an open side that is at partially enclosed by a slot plate that is attached to the non-metallic substrate. In some instances, the waveguide channel with the attached slot plate has a rectangular-shaped cross-section. The slot plate has a plurality of slots aligned along the first direction of the substrate such that at least parts of the plurality of slots are in fluid communication with the waveguide channel. The slot plate also has a metallic inner surface facing the waveguide channel. In some instances, the waveguide antenna structure includes a wave generator that is attached to the substrate and operable to generate an electromagnetic wave and propagate the wave through the inlet channel and into the waveguide channel.

The non-metallic substrate can be made from plastic and in some instances is made by injection molding. The metallic coating that is present on at least part of the waveguide channel and the inlet channel can have a composition that includes aluminum, copper, silver, gold, iron, nickel, cobalt, and/or alloys thereof. In addition, the slot plate can have a metallic coating and/or be a metallic component that has a composition that includes aluminum, copper, silver, gold iron, nickel, cobalt, and/or alloys thereof.

The substrate can have a step surface that aids in aligning the slot plate with the waveguide channel, the slot plate being at least partially in contact with the step surface when attached to the substrate. In some instances, the step surface is a recess that is adjacent to and surrounds the waveguide channel and the slot plate fits at least partially within the recess. The non-metallic substrate and/or slot plate can also include an alignment pin and/or alignment aperture that aids in the alignment of the slot plate with the alignment pin extending at least partially into the alignment aperture when the slot plate is attached to the substrate.

The waveguide channel can have a central axis along the first direction and the plurality of slots of the slot plate can be aligned parallel to the central axis. In addition, the plurality of slots can be spaced apart from the central axis with every other slot spaced apart on opposite sides of the central axis such that the slots are staggered about the axis.

A process for making the waveguide antenna structure includes injection molding a plastic substrate with a waveguide channel extending in a first direction and an inlet channel extending in a second direction. It is appreciated that the inlet channel intersects the waveguide channel and can afford for a wave generator to propagate electromagnetic waves into the waveguide channel. The waveguide channel and the inlet channel are at least partially coated with a metallic material, the metallic coating having a composition that includes aluminum, copper, silver, gold, iron, nickel, cobalt, and/or alloys thereof. The process also includes providing a plate and forming a plurality of slots in the plate such that the plurality of slots are aligned with the first direction of the plastic substrate and are in fluid communication with the waveguide channel when the plate is attached to the substrate. The plate can be a non-metallic plate that is at least partially coated with a metallic material or in the alternative be made from a metallic material. After the plate is provided, it is attached to the substrate. The injection molding of the plastic substrate can provide for an alignment pin and/or an alignment aperture that aids in the aligning of the plate when it is attached thereto. In addition, the plate can have an alignment aperture and/or alignment pin, the alignment pin extending at least partially into the alignment aperture when the plate is attached to the substrate.

### BRIEF DESCRIPTION OF THE DRAWINGS

FIG. 1 is a perspective view of a waveguide substrate and a slot plate before assembly;

FIG. 2 is a top view of a portion of the slot plate illustrating the slots being spaced apart from a central axis;

FIG. 3 is a sectional view of the section labeled 3-3 in FIG. 1;

FIG. 4 is an end cross-sectional view of the embodiment shown in FIG. 1 before the slot plate is attached to the substrate;

FIG. 5 is a cross-sectional view of the embodiment shown in FIG. 1 after the slot plate is attached to the substrate;

FIG. 6 is an end cross-sectional view of another embodiment of the present invention;

FIG. 7 is an end perspective view illustrating the embodiment shown in FIG. 6 before the slot plate is attached to the substrate and the addition of a wave generator;

FIG. 8 is an end cross-sectional view of another embodiment of the present invention;

FIG. 9 is a top view of an assembly of waveguide antenna structures;

FIG. 10 is a perspective view of an inlet channel and a waveguide channel according to an embodiment of the present invention;

FIG. 11 is a graphical representation of the return loss as a function of resonant cavity length; and

FIGS. 12A-12D schematically illustrates various waveguide structures and/or geometries according to embodiments of the present invention.

### DETAILED DESCRIPTION OF THE INVENTION

The present invention discloses a waveguide antenna structure and a method of manufacture. As such, the waveguide antenna structure has utility as a component for a long-range radar.

The waveguide antenna structure can include a non-metallic substrate having a waveguide channel extending along a first direction and an inlet channel extending along a second direction. In some instances, the non-metallic substrate is an elongated substrate and the first direction is a longitudinal direction and the second direction is a transverse direction of the elongated substrate. The inlet channel intersects the waveguide channel and both channels are at least partially coated with a metallic material. In some instances, the inlet channel, also known as the inlet port or input port, is integral with the non-metallic substrate and is made or formed when the waveguide channel is made/formed, e.g. during a one-shot injection molding process.

The waveguide channel can have a generally U-shaped cross-section with an open side that is at partially enclosed by a slot plate that is attached to the non-metallic substrate. In some instances, the waveguide channel with the attached slot plate has rectangular-shaped cross-section, however, this is not required. The slot plate has a plurality of slots, the plurality of slots located such that they are aligned along the first direction of the substrate when the slot plate is attached thereto. In addition, at least parts of the plurality of slots are in fluid communication with the waveguide channel when the slot plate is attached to the substrate. The slot plate can be made from a non-metallic material and have a metallic inner surface facing the waveguide channel, or in the alternative, be made from a metallic material.

The non-metallic substrate can be made from plastic and in some instances is made by injection molding. The metallic coating that is present on at least part of the waveguide channel and the inlet channel can have a composition that includes aluminum, copper, silver, gold, iron, nickel, cobalt, and/or alloys thereof. In addition, the slot plate can have a metallic coating and/or be a metallic component that has a composition that includes aluminum, copper, silver, gold iron, nickel, cobalt, and/or alloys thereof.

The non-metallic substrate can have a step surface that aids in aligning the slot plate with the waveguide channel, the slot plate being at least partially in contact with the step surface when attached to the substrate. In some instances, the step surface is a recess that is adjacent to and surrounds the waveguide channel and the slot plate fits at least partially within the recess. In other instances, the slot plate can have a recess that is complimentary to the step surface of the substrate. The non-metallic substrate and/or slot plate can also include an alignment pin and/or alignment aperture that aids in the alignment of the slot plate, the alignment pin extending at least partially into the alignment aperture when the slot plate is attached to the substrate.

The waveguide channel can have a central axis along the first direction and the plurality of slots of the slot plate can be aligned parallel to the central axis. In addition, the plurality of slots can be spaced apart from the central axis with every other slot spaced apart on opposite sides of the central axis such that the slots are staggered about the axis.

In some instances, the waveguide antenna structure includes a wave generator that is attached to the substrate and operable to generate an electromagnetic wave and propagate the wave through the inlet channel and into the waveguide channel.

A process for making the waveguide antenna structure can include forming a plastic substrate with a waveguide channel extending in a first direction and an inlet channel extending in a second direction. The plastic substrate can be formed using any process known to those skilled in the art, illustratively including injection molding, hot embossing, extrusion and the like. It is appreciated that the inlet channel intersects the waveguide channel and can afford for a wave generator to propagate electromagnetic waves into the waveguide channel.

The waveguide channel and the inlet channel are at least partially coated with a metallic material, the metallic coating having a composition that includes aluminum, copper, silver, gold, iron, nickel, cobalt, and/or alloys thereof. The process also includes providing a plate and forming a plurality of slots in the plate such that the plurality of slots are aligned with the first direction of the plastic substrate and are in fluid communication with the waveguide channel when the plate is attached to the substrate. The plate can be a non-metallic plate that is at least partially coated with a metallic material or in the alternative be made from a metallic material. After the plate is provided, it is attached to the substrate. The plastic substrate and/or plate can have for an alignment pin and/or an alignment aperture that aids in the aligning of the plate when it is attached thereto, the alignment pin extending at least partially into the alignment aperture when the plate is attached to the substrate.

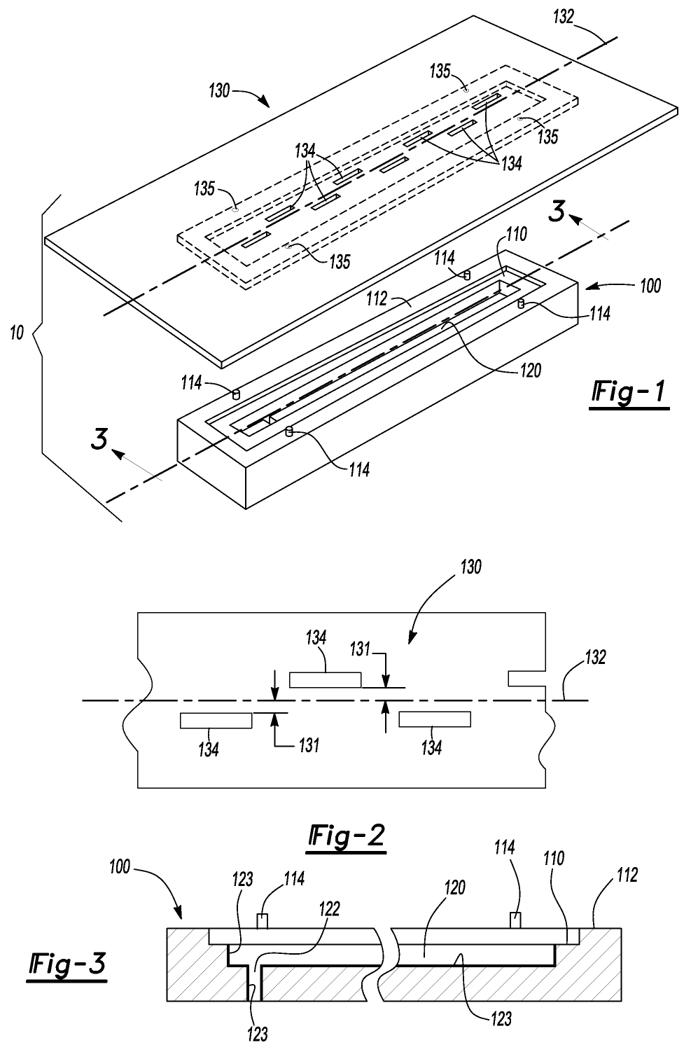

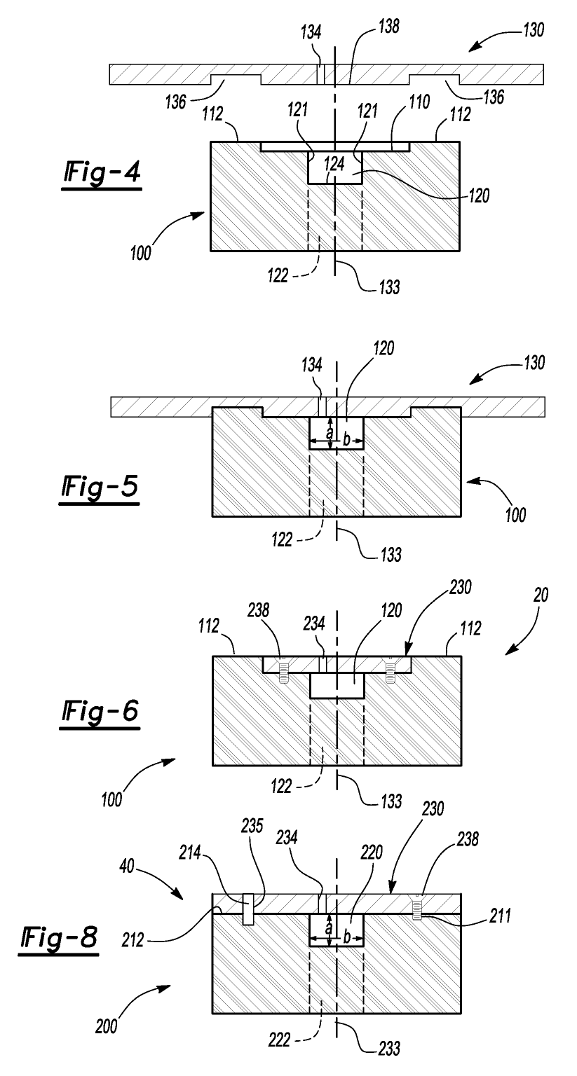

Turning now to FIGS. 1-5, an embodiment of a waveguide antenna structure is shown generally at reference numeral 10. The waveguide antenna structure 10 can include a non-metallic substrate 100 with a waveguide channel 120 extending in a first direction and an inlet channel 122 extending in a second direction. In some instances, the non-metallic substrate is made from plastic and can have an elongated structure with the first direction extending in a longitudinal direction and the second direction extending in a transverse direction. As shown best in FIG. 4, the waveguide channel 120 can have a side wall 121 and a bottom wall 124. In some instances, the waveguide channel 120 can have an U-shaped cross section, however this is not required. It is appreciated that a height ‘a’ and a width ‘b’ of the waveguide channel 120 are dictated by the boundary conditions of electromagnetic waves to be propagated therethrough.

Attached to the non-metallic substrate 100 is a slot plate 130, the slot plate 130 having a plurality of slots 134. As shown in FIG. 1, the waveguide channel 120 has a central axis 132, with the plurality of slots 134 aligned parallel to the central axis 132 when the slot plate 130 is attached to the substrate 100. In some instances, the plurality of slots 134 can be spaced apart from the central axis 132 a predetermined distance 131. For example, every other slot 134 can be spaced apart on opposite sides of the axis 132 such that the slots are staggered about the axis as illustrated in FIG. 2.

The non-metallic substrate 100 can have a step surface 110 that aids in the alignment of the slot plate 130 with the waveguide channel 120. In addition, the slot plate 130 can have a complimentary step surface 136 and/or 138 that affords for the slot plate 130 to be at least partially in contact with the step surface 110 when the plate 130 is attached to the substrate 100. In addition, the step surfaces 136 and/or 138 of the slot plate 130 can align with a ledge surface 112 of the substrate 100 such that the alignment is ensured when the plate 130 is attached to the substrate 100.

The substrate 100 can have one or more alignment pins 114 that extend at least partially into alignment apertures 135 of the slot plate 130 when the plate 130 is attached to the substrate 100. In the alternative, the substrate 100 can have an alignment aperture and the slot plate 130 can have an alignment pin. In this manner, the step surface 110, alignment pin 114, step surfaces 136 and/or 138 and/or alignment aperture 135 ensure that the plurality of slots 134 are in a desired position relative to the waveguide channel 120 and inlet channel 122. Although not shown, the slot plate 130 can be attached to the non-metallic substrate 100 using any method or means known to those skilled in the art, illustratively including adhesives, threaded fasteners, welding, diffusion bonding and the like.

At least part of the waveguide channel 110 and inlet channel 122 is coated with a metallic material 123. The metallic coating can have a composition that includes aluminum, copper, silver, gold, iron, nickel, cobalt, and/or alloys thereof. The coating can be applied to the non-metallic substrate 100 using any method known to those skilled in the art, illustratively including evaporation, sputtering, electroplating, electroless plating, physical vapor deposition (PVD), chemical vapor phase deposition (CVD) and the like. It is appreciated that the non-metallic substrate 100 having the metallic coating 123 thereon provides a surface that is smooth enough to properly propagate electromagnetic wave frequencies suitable for long-range radar applications. For example, the waveguide antenna structure 10 is suitable to be used for 77 GHz automotive radar applications.

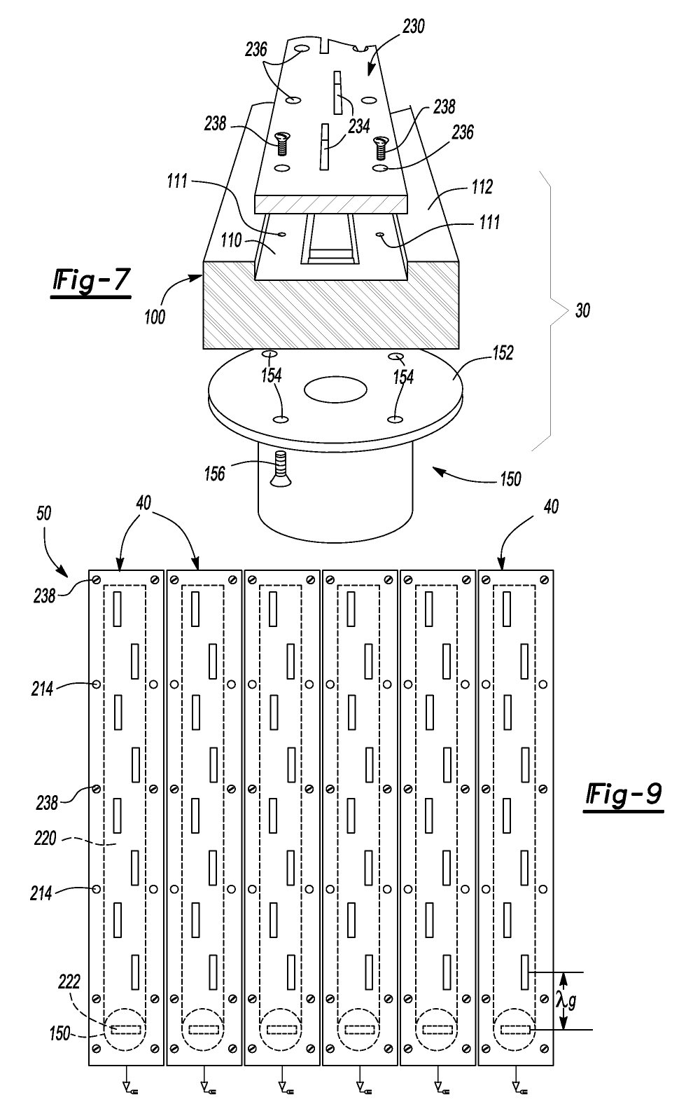

Turning now to FIGS. 6-7, another embodiment of a waveguide antenna structure is shown generally at reference numeral 20. As shown in FIG. 6, wherein like numerals correspond to like elements in the previous figures, the non-metallic substrate 100 has the waveguide channel 120 and the inlet channel 122. However in contrast to the previous embodiment 10, the embodiment 20 includes a slot plate 230 that fits within the step surface 110 as shown in FIG. 6. In addition, the slot plate 230 has one or more apertures 236 through which threaded fastener 238 can extend therethrough into a threaded aperture 111 of the substrate 100 in order to attach the slot plate 230 to the substrate 100. Although not shown, it is appreciated that the substrate 100 could also include one or more alignment pins and/or alignment apertures, for example along the step surface 110, and the slot plate 230 could include one or more alignment apertures and/or alignment pins such that the alignment pin extends at least partially into the alignment aperture and thereby aid in the alignment of the slot plate 230 when it is attached to the non-metallic substrate 100.

Looking specifically at FIG. 7, a wave generator 150 is shown, the wave generator 150 having a flange 152 with apertures 154. The wave generator 150 can be attached to the substrate 100 using a threaded fastener 156 such that electromagnetic waves generated by the wave generator 150 can propagate through the inlet channel 122 into the waveguide channel 120. It is appreciated that the wave generator 150 can be attached to the substrate 100 using other methods and/or means, illustratively including adhesives, tape, clamps and the like. In this manner, electromagnetic waves are afforded to propagate out of the plurality of slots 234 of the slot plate 230. In addition, the plurality of slots 234 can receive electromagnetic waves which propagate back through the waveguide channel 120 and inlet channel 122. It is appreciated that the wave generator 150 can also serve as a wave receiver such that a desired long-range radar is provided.

Turning now to FIG. 8 where like numerals correspond to like elements in the previous figures, another embodiment of a waveguide antenna structure is shown generally at reference numeral 40. The waveguide antenna structure 40 includes a non-metallic substrate 200 having a waveguide channel 220 and an inlet channel 222. It is appreciated that the waveguide channel 220 and the inlet channel 222 extend along a first direction and a second direction, respectively, similar to the embodiments described in the previous figures. The substrate 200 and/or slot plate 230 can include one or more alignment pins 214 and/or alignment apertures 235 that afford alignment of the slots 234 relative to the waveguide channel 220. In addition, threaded fasteners 238 can be used to attach the slot plate to the substrate 200. It is appreciated that the plurality of slots 234 can be aligned relative to a central axis as described above for the previous embodiments.

Turning now to FIG. 9, an assembly of waveguide antenna structures is shown at reference numeral 50. The assembly 50 can have a plurality of waveguide antenna structures 40 as shown, or in the alternative have a plurality of waveguide structures 10, 20 and/or 30, and thereby provide a two dimensional configuration. The assembly 50 can include a wave generator 150 for each of the waveguide antenna structures 40 or in the alternative a single wave generator can be used to transmit and/or receive electromagnetic waves for the entire assembly. In addition, the slots 234 can be spaced apart from the inlet channel 222 by a predetermined distance. In some instances the predetermined distance is an integer multiple of λ_{g}, λ_{g} being defined by the relationship:

$${λ}_{g} = \frac{{λ}_{o}}{\sqrt{1 - {( \frac{{λ}_{o}}{2 a} )}^{2}}}$$

where λₒ is the wavelength of the electromagnetic wave in free space that is to propagate through the waveguide channel and ‘a’ is the width of the waveguide channel (Should ‘a’ and ‘b’ be changed in FIG. 8?). It is appreciated that the spacing between the slots 234 in both planes, including a 45° diagonal plane/direction, can be optimized such that side lobe and grating lobe levels are reduced. In addition, mutual coupling between the slots 234 of adjacent waveguide antenna structures 40 can be taken into account in order to reduce side lobe levels and/or scan blindness.

It is appreciated that the assembly 50 affords for a long-range radar that propagates electromagnetic waves into three-dimensional space and receives electromagnetic waves that have bounced off of objects to provide desirable information regarding the location of the objects. In some instances, the assembly 50 can be part of a motor vehicle and used as part of an automatic speed controlled cruise control. Other uses will occur to those skilled in the art and are not restricted to long-range use radars for motor vehicles.

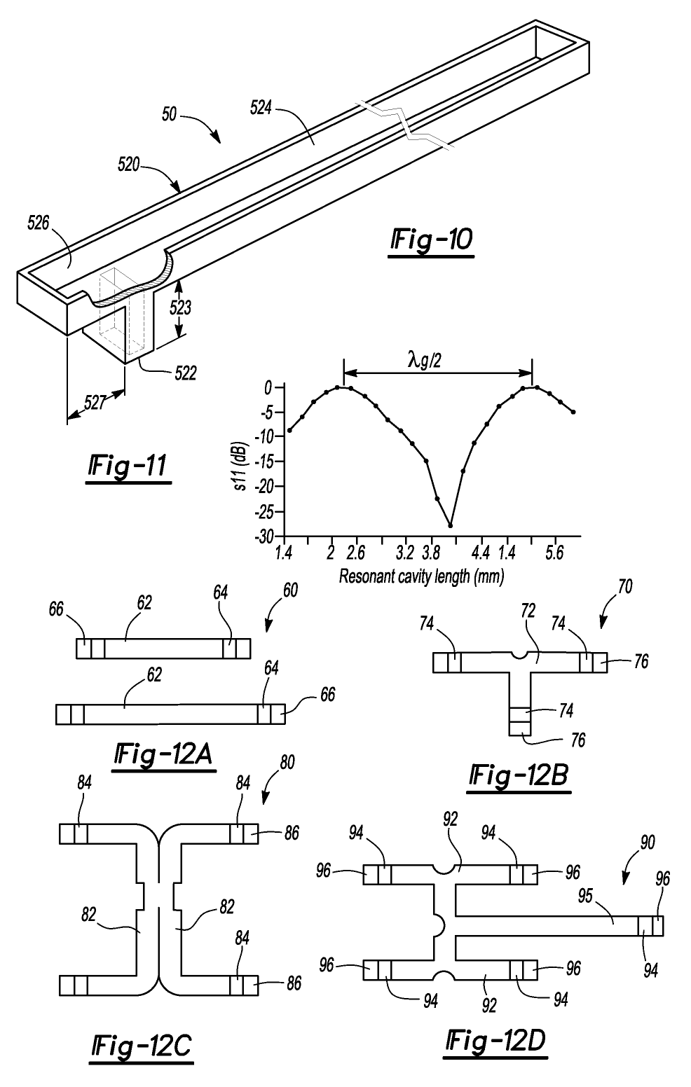

Referring to FIG. 10, an assembly 50 can have a waveguide channel 520 with an interesting inlet channel 522, the waveguide channel 520 having a long portion 524 extending from one side of the intersection between the inlet channel 522 and the waveguide channel 520, and a short portion 526 extending from an opposite side of the intersection. The short portion 526 can be a resonant cavity having a length 527. In addition, the inlet channel can have a length 523. It is appreciated that the inlet channel length 523 and the resonant cavity length 527 can be designed/selected in order to reduce the return loss to the 90-degree E-plane bend between the waveguide channel 520 and the inlet channel 522. For example, FIG. 11 illustrates a simulated result on the effect of resonant cavity length on return loss. As shown in the figure, a periodic response of approximately half of a wave length can be observed. As such, a desired resonant cavity length and/or inlet channel length can be used designed/calculated in order to minimize the impedance mismatch.

FIGS. 12A-12D schematically illustrate other embodiments of waveguide antenna assemblies. For example and for illustrative purposes only, a waveguide antenna assembly 60 can include a single waveguide channel 62 having two or more inlet channels 64, and optionally corresponding resonant cavities 66, as shown in FIG. 12A. In the alternative, FIG. 12B illustrates a T-junction waveguide antenna assembly 70 can have a generally T-shape waveguide channel 72 with one or more inlet channels 74. Resonant cavities 76 can also be included.

A hybrid coupler waveguide antenna assembly 80 can have a pair of waveguide channels 82 that are coupled at a coupling location 83, along with one or more inlet channels 84 and resonant cavities 86 as shown in FIG. 12C. And a 2×2 feeding network waveguide antenna assembly 90 can include a pair of parallel waveguide channels 92 connected with a connecting channel 93, plus an additional feeding channel 95 as shown in FIG. 12D. As such, the waveguide channel can have generally any shape that provides a useful waveguide antenna assembly, for example and as described above, a T-shape, a hybrid coupler shape, a 2×2 feeding network shape and combinations thereof.

It is appreciated that such structured or shaped waveguide antenna assemblies can also include resonant cavities 66, 76, 86 and 96 as shown in the FIGS. 12A, 12B, 12C and 12D, respectively. In this manner new and/or customized waveguide antenna assemblies can be provided. In addition, it is appreciated that the waveguide assemblies illustrated in FIGS. 12A-12D include the various components as described in the previous embodiments, such as slot plates, alignment apertures, alignment pins and the like, and that the waveguide channels, inlet channels, etc. can be made a non-metallic material and coated with a metallic material as described above.

The slot plates can also be made from a non-metallic material that has been at least partially coated with a metallic coating. In the alternative, the slot plates can be a metallic plate. The slot plates can be machined in order to provide the slots, apertures, pins and the like. By using the non-metallic substrate and the slot plate, any elements that require precise machining can be reserved for or made from the slot plate and thus reduce the manufacturing cost of the waveguide antenna structure. The non-metallic substrate and/or a non-metallic slot plate can be made from any non-metallic material known to those skilled in the art, illustratively including plastics, ceramics, and the like.

Although the invention has been described in detail with respect to various embodiments and examples, it is appreciated that the invention is not limited thereto. Rather, modifications and variations that would present themselves to those with skill in the art without departing from the scope and spirit of this invention are included. Thus it is the claims which define the scope of the invention.

We claim:

1. A waveguide comprising:
a non-metallic substrate having a waveguide channel extending along a first direction and an inlet channel extending along a second direction, said inlet channel intersecting said waveguide channel;
said waveguide channel and said inlet channel being at least partially coated with a metallic material; and
a slot plate attached to said non-metallic substrate adjacent said waveguide channel, said slot plate having a plurality of slots aligned along said first direction such that at least part of said plurality of slots are in fluid communication with said waveguide channel, said slot plate also having a metallic inner surface facing said waveguide channel.

2. The waveguide of claim 1, further comprising a wave generator attached to said substrate and operable to generate an electromagnetic wave and propagate said electromagnetic wave into said inlet channel.

3. The waveguide of claim 1, wherein said non-metallic substrate is a plastic substrate.

4. The waveguide of claim 3, wherein said plastic substrate is an injection molded plastic substrate.

5. The waveguide of claim 3, wherein said metallic material is selected from the group consisting of aluminum, copper, silver, gold, iron, nickel, cobalt, and alloys thereof.

6. The waveguide of claim 1, wherein said slot plate is a metallic slot plate.

7. The waveguide of claim 6, wherein said metallic slot plate is made from a material selected from the group consisting of aluminum, copper, silver, gold, iron, nickel, cobalt, and alloy thereof.

8. The waveguide of claim 1, wherein said waveguide channel has a generally U-shaped cross-section.

9. The waveguide of claim 8, wherein said slot plate at least partially encloses said waveguide channel when attached to said substrate.

10. The waveguide of claim 1, wherein said substrate has a step surface, said slot plate at least partially in contact with said step surface when attached to said substrate.

11. The waveguide of claim 10, wherein said step surface is a recess adjacent to and surrounding said waveguide channel.

12. The waveguide of claim 11, wherein said slot plate fits at least partially within said recess when attached to said substrate.

13. The waveguide of claim 1, wherein said substrate has an alignment pin, said alignment pin aiding in alignment of said slot plate when attached to said substrate.

14. The waveguide of claim 13, wherein said slot plate has an alignment aperture, said alignment pin of said substrate extending at partially into said alignment aperture when said slot plate is attached to said substrate.

15. The waveguide of claim 1, wherein said slot plate has a recess, said substrate fitting within at least part of said recess when said slot plate is attached to said substrate.

16. The waveguide of claim 1, wherein said slot plate has a first slot located a predetermined distance from said inlet channel when attached to said substrate, said predetermined distance defined by the relationship:
$${λ}_{g} = \frac{{λ}_{o}}{\sqrt{1 - {( \frac{{λ}_{o}}{2 a} )}^{2}}}$$
where λ_{g} is said predetermined distance of said first slot from said inlet channel, λₒ is the wavelength of an electromagnetic wave in free space propagating through said waveguide channel and a is a width of said waveguide channel.

17. The waveguide of claim 1, wherein said waveguide channel has a central axis along said first direction.

18. The waveguide of claim 17, wherein said plurality of slots of said slot plate are aligned parallel said central axis.

19. The waveguide of claim 18, wherein said plurality of slots are spaced apart from said central axis.

20. The waveguide of claim 19, wherein at least part of said plurality of slots are aligned on one side of said central axis and at least part of said plurality of slots are aligned on another side of said central axis.

21. The waveguide of claim 1, wherein said waveguide channel has a long portion and a short portion, said long portion extending from one side of where said inlet channel intersects said waveguide channel and said short portion extends oppositely from said long portion.

22. The waveguide of claim 1, wherein said waveguide channel has a shaped selected from the group consisting of a T-shape, a hybrid coupler shape, a 2×2 feeding network shape and combinations thereof.

23. A process for making a waveguide, the process comprising:
injection molding a plastic substrate with a waveguide channel extending in a first direction and an inlet channel extending in a second direction, said inlet channel intersecting the waveguide channel;
coating at least part of the waveguide channel and the inlet channel with a metallic material;
providing a metallic plate;
forming a plurality of slots in the metallic plate such that the plurality of slots are in fluid communication with the waveguide channel when the metallic plate is attached to the substrate;
attaching the metallic plate with the plurality of slots onto the substrate.

24. The process of claim 23, further comprising providing a wave generator that can generate electromagnetic waves and attaching the wave generator to the plastic substrate such that generated electromagnetic waves can propagate through the inlet channel into the waveguide channel.

25. The process of claim 23, wherein the metallic material is selected from the group consisting of aluminum, copper, silver, gold, iron, nickel, cobalt, and alloys thereof.

26. The process of claim 23, wherein the metallic plate is made from a material selected from the group consisting of aluminum, copper, silver, gold, iron, nickel, cobalt, and alloys thereof.

27. The process of claim 23, wherein the plastic substrate has an alignment pin that aids in aligning the metallic plate when it is attached to the plastic substrate.

28. The process of claim 27, wherein the metallic plate has an alignment aperture, the alignment pin extending at least partially into the alignment aperture when the metallic plate is attached to the plastic substrate.

29. The process of claim 23, wherein the waveguide channel has a long portion and a short portion, the long portion extending from one side of where the inlet channel intersects the waveguide channel and the short portion extends oppositely from said long portion.

30. The waveguide of claim 23, wherein the waveguide channel has a shaped selected from the group consisting of a T-shape, a hybrid coupler shape, a 2×2 feeding network shape and combinations thereof.
